(19) United States
(12) Patent Application Publication
(10) Pub. No.: US 2017/0331689 A1
(43) Pub. Date: Nov. 16, 2017

(54) METHOD AND SYSTEM OF FACILITATING SOCIAL INTERACTIONS OF USERS

(71) Applicant: TRUEPAL LLC, Cupertino, CA (US)

(72) Inventor: Ankush GUPTA, Cupertino, CA (US)

(21) Appl. No.: 14/862,138

(22) Filed: Sep. 22, 2015

(51) Int. Cl. H04L 12/24; H04L 29/08

(52) U.S. Cl. CPC H04L 41/0893; H04L 67/22; H04L 67/306

(57) ABSTRACT

A method and a system for facilitating social interactions of users are provided. The method includes provisioning a networking application to a user device. The networking application is configured to facilitate a formation of a social network for a user upon user registration. The social network includes a plurality of members related to the user within a pre-defined degree of separation. Each member is associated with a credibility metric value. Further, the method includes receiving user input indicative of user's interest to interact with other members on the social network. Moreover, the method includes dynamically creating a sub-network of members for the user to interact with upon receiving the user input. The sub-network of members is created by pruning one or more members from among the plurality of members associated with the social network at least based on the credibility metric value for the each member.

### TECHNICAL FIELD

The present invention generally relates to online user interactions and more specifically to a method and system for facilitating social interactions of the users.

### BACKGROUND

A volume of online social interactions, i.e. interactions of individuals with one another or with a group of individuals on the web medium (or through the Internet), has increased exponentially with increasing ubiquity of mobile devices and mobile applications that facilitate such social interactions. People may engage in social interactions with their friends or even with strangers for a variety of purposes. For example, a user may engage in a social interaction with a group of friends to share information such as information related to important events in his/her life, general news information, images of places he/she has visited, his/her opinion or viewpoints on a recent event and the like. In another example scenario, a user may engage in a social interaction to buy a product or a service from another user. In yet another example, a user may pose a query on a web forum for other users of the web forum to respond to. In scenarios, involving purchase of products or receiving answers to questions seeking assistance, it would be beneficial if a user can avoid interactions with individuals whose credibility the user is not sure of and instead only interact with individuals whose reputation the user is assured of. Moreover, it is desirable to enable the user to interact with credible people in a convenient manner.

### SUMMARY

This summary is provided to introduce a selection of concepts in a simplified form that are further described below in the detailed description. This summary is not intended to identify key or essential features of the claimed subject matter, nor is it intended to be used as an aid in determining the scope of the claimed subject matter.

Various methods and systems for facilitating social interactions of users are disclosed. In an embodiment, a computer-implemented method of operating a social networking system is disclosed. The method includes provisioning a networking application to a user device. The networking application, upon user registration, is configured to facilitate a formation of a social network for a user. The social network includes a plurality of members related to the user within a pre-defined degree of separation and each member from among the plurality of members is associated with a credibility metric value. Further, the method includes receiving user input indicative of user's interest to interact with other members on the social network. Moreover, the method includes dynamically creating a sub-network of members for the user to interact with upon receiving the user input. The sub-network of members is created by pruning one or more members from among the plurality of members associated with the social network at least based on the credibility metric value for the each member.

In another embodiment, a social networking system is disclosed. The social networking system includes a database and a social interaction platform in operative communication with the database. The social interaction platform is communicably associated with a plurality of user devices and is capable of provisioning a networking application to each user device from among the plurality of user devices. The networking application in conjunction with the social interaction platform is configured to facilitate, upon user registration, a formation of a social network for a user of a user device. The social network includes a plurality of members related to the user within a pre-defined degree of separation and each member from among the plurality of members is associated with a credibility metric value. Moreover, the social interaction platform is configured to receive user input indicative of user's interest to interact with other members on the social network and dynamically create a sub-network of members for the user to interact with upon receiving the user input. The sub-network of members is created by pruning one or more members from among the plurality of members associated with the social network at least based on the credibility metric value for the each member.

In another embodiment, a computer program is disclosed. The computer program includes instructions which when executed by a user device causes the user device to facilitate upon user registration, a formation of a social network for a user of the user device. The social network includes a plurality of members related to the user within a pre-defined degree of separation and each member from among the plurality of members is associated with a credibility metric value. Further, the user device is caused to receive user input indicative of user's interest to interact with other members on the social network, where a sub-network of members for the user to interact with is dynamically created based on the user input. The sub-network of members is created by pruning one or more members from among the plurality of members associated with the social network at least based on the credibility metric value for the each member. Furthermore, the user device is caused to display interaction messages from the sub-network of members.

Other aspects and example embodiments are provided in the drawings and the detailed description that follows.

### BRIEF DESCRIPTION OF THE FIGURES

For a more complete understanding of example embodiments of the present invention, reference is now made to the following descriptions taken in connection with the accompanying drawings in which:

FIG. 1 illustrates an example social networking environment, in accordance with an embodiment of the invention;

FIG. 2 illustrates an example representation of a social network configured for a user by a social interaction platform of FIG. 1, in accordance with an embodiment of the invention;

FIG. 3 illustrates an example representation of a sub-network of members created dynamically by the social interaction platform of FIG. 1 upon receiving the user's request, in accordance with an embodiment of the invention;

FIG. 4A shows a diagram illustrating an example representation of a first user interface (UI) presented to a user on a user device upon accessing a networking application, in accordance with an embodiment of the invention;

FIG. 4B shows a diagram illustrating an example representation of a second UI presented to the user on the user device by the networking application upon user login, in accordance with an embodiment of the invention;

FIG. 5 shows a diagram illustrating an example representation of a third UI presented to the user on the user device, in accordance with an embodiment of the invention;

FIG. 6 shows a diagram illustrating an example representation of a fourth UI presented to the user on the user device, in accordance with an embodiment of the invention;

FIGS. 7A, 7B and 7C show diagrams illustrating an example representation of a fifth UI displaying a plurality of categories to enable a user to customize a message feed of interaction messages, in accordance with an embodiment of the invention;

FIG. 8 shows a diagram illustrating an example representation of a sixth UI presented to the user for viewing a message feed related to questions and answers being exchanged among various members in the sub-network, in accordance with an embodiment of the invention;

FIG. 9 shows a diagram illustrating an example representation of a seventh UI presented to the user for enabling the user to post an interaction message for display to other members of the user's social network, in accordance with an embodiment of the invention;

FIG. 10 shows a diagram illustrating an example representation of options provided to the user on the seventh UI for enabling the user to post an interaction message for display to other members of the user's social network, in accordance with an embodiment of the invention;

FIG. 11 shows a diagram illustrating an example representation of an eighth UI presented to the user for enabling the user to search for desired information, in accordance with an embodiment of the invention; and

FIG. 12 illustrates a flow diagram of an example method for facilitating user social interactions, in accordance with an example embodiment.

### DETAILED DESCRIPTION

In the following description, for purposes of explanation, numerous specific details are set forth in order to provide a thorough understanding of the present invention. It will be apparent, however, to one skilled in the art that the present invention can be practiced without these specific details. In other instances, systems and methods are shown in block diagram form only in order to avoid obscuring the present invention.

Reference in this specification to “one embodiment” or “an embodiment” means that a particular feature, structure, or characteristic described in connection with the embodiment is included in at least one embodiment of the present invention. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Moreover, although the following description contains many specifics for the purposes of illustration, anyone skilled in the art will appreciate that many variations and/or alterations to said details are within the scope of the present invention. Similarly, although many of the features of the present invention are described in terms of each other, or in conjunction with each other, one skilled in the art will appreciate that many of these features can be provided independently of other features. Accordingly, this description of the present invention is set forth without any loss of generality to, and without imposing limitations upon, the present invention.

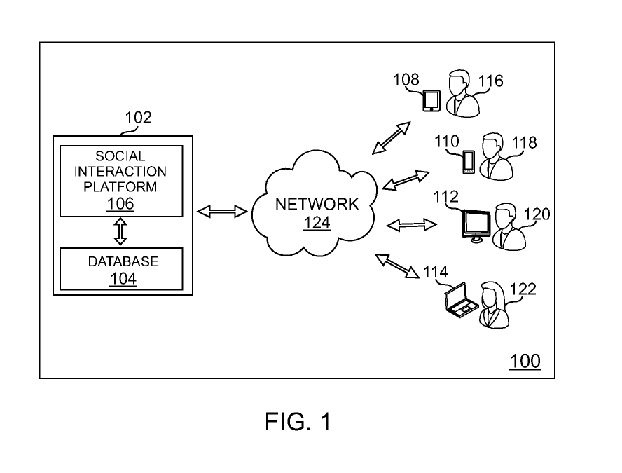

FIG. 1 illustrates an example social networking environment 100 in accordance with an embodiment of the invention. The social networking environment 100 depicts a social networking system 102 including a database 104 and a social interaction platform 106. The social interaction platform 106 and the database 104 are communicably associated with each other. For example, the social interaction platform 106 and the database 104 may be communicably associated with each other using a communication bus, such as a data bus, or using a centralized circuit system including printed circuit assemblies, such as printed circuit boards, and the like.

In at least one example embodiment, the social interaction platform 106 may be implemented completely as a set of software layers on top of existing hardware systems. In at least one embodiment, the database 104 may be embodied as one or more volatile memory devices, one or more non-volatile memory devices, and/or a combination of one or more volatile memory devices and non-volatile memory devices. For example, the database 104 may be embodied as magnetic storage devices (such as hard disk drives, floppy disks, magnetic tapes, etc.), optical magnetic storage devices (e.g. magneto-optical disks), CD-ROM (compact disc read only memory), CD-R (compact disc recordable), CD-R/W (compact disc rewritable), DVD (Digital Versatile Disc), BD (Blu-ray® Disc), and semiconductor memories (such as mask ROM, PROM (programmable ROM), EPROM (erasable PROM), flash ROM, RAM (random access memory), etc.).

It is noted that the social networking system 102 may include fewer or more components than those depicted in FIG. 1. Moreover, the social networking system 102 may be implemented as a centralized apparatus, or, alternatively, the components of the social networking system 102 may be deployed in a distributed manner while being operatively coupled to each other. In an embodiment, the social networking system 102 may be embodied as a mix of existing open systems, proprietary systems and third party systems. In an exemplary scenario, the social networking system 102 may be any machine capable of executing a set of instructions (sequential and/or otherwise) so as to facilitate social interactions between users.

In at least one example embodiment, the social interaction platform 106 is communicably associated with a plurality of user devices, such as user devices 108, 110, 112 and 114 associated with users 116, 118, 120 and 122, respectively. Non-exhaustive examples of the user devices (also referred to herein as member devices) may include electronic devices, such as mobile phones, laptops, Smartphones, tablet devices, wearable devices and the like. In at least one embodiment, the social interaction platform 106 may be communicably associated with the plurality of user devices over a communication network, such as a network 124. Examples of the network 124 may include, but are not limited to, a wired network, a wireless network, or a combination thereof. Examples of wired network may include Ethernet, local area network (LAN), fiber-optic cable network and the like. Examples of wireless network may include cellular network like GSM (global system for mobile communication), 3G (third-generation), 4G (fourth-generation), CDMA (code division multiple access) based network, wireless LAN, Bluetooth® network, Zigbee® network, and the like. An example of a combination of wired and wireless network may include the Internet.

In at least one example embodiment, the social interaction platform 106 is configured to provision a networking application to the user devices. The networking application may be provisioned to the users upon user request. For example, a user may access an application store associated with an operating system (OS) installed in the user device to request the networking application. Upon receipt of such a request, the social interaction platform 106 may be configured to provision the networking application to the user device. The user may then register his credentials on the networking application to create a user profile. It is understood that though the user can request the networking application using the application store, however, in some cases the networking application may be factory-installed within the user device. In such a case, the provisioning of the networking application by the social interaction platform 106 may imply downloading of the networking application during device manufacture or at any stage prior to purchase of the user device by the user.

In an example embodiment, the networking application is configured to facilitate, upon user registration, a formation of a social network for the user. The social network includes a plurality of members related to the user within a pre-defined degree of separation. The formation of the social network is further explained with reference to following illustrative example.

In an example scenario, the user device is a mobile phone (or a smartphone) and configured to store contact information of a plurality of user contacts related to the user, for example a user A. Furthermore, the mobile phone is associated with a phone number (considered to be unique for purposes of the description). The networking application is configured to access the contact information, such as phone numbers of the plurality of user contacts of the user A and provision the phone numbers to the social interaction platform 106 in order to facilitate the formation of the social network for the user A. The social interaction platform 106 may further be configured to identify at least one user contact, for example user contact B, who is associated with the networking application, or in other words, who has downloaded the networking application on his/her respective device and is registered with the social networking system 102. For such a user contact B, the social interaction platform 106 may also be in possession of the contact information of his/her contacts. In one embodiment, the social interaction platform 106 is configured to check if the user contact B has stored the phone number of the user A on his/her device. If the user contact B has stored the phone number of the user A on his/her device, implying both individuals A and B have each other's numbers stored in their devices, then the social interaction platform 106 may determine the user contact B to be a friend of the user A. In an example scenario, if a user, for example, a user C has not stored the user A's phone number, whereas the user A has stored the user C's phone number on his/her user device, then the social interaction platform 106 may be configured to automatically (or in some cases with user consent) send a friend request to the user C. Upon acceptance of the friend request by the user C, the user C may be determined to be a friend of the user A. If the friend request is not accepted by the user C or till the time the friend request is not accepted by the user C, the user C may be determined to be an acquaintance of the user A. In some cases, the one or more user contacts may not be associated with the networking application, or in other words, may not have downloaded the networking application or are not registered with the social networking system 102. In such a scenario, the social interaction platform 106 may be configured to configure a message requesting the user, for example a user D, to download the networking application and register with the social networking system 102. The social interaction platform 106 may also in some cases include pictures of users, such as that of the user A, who are currently using the networking application so as to incentivize users, such as the user D, to download the networking application and register with the social networking system 102. If the message is ignored by the user D or till the time the user D is not registered with the social networking system 102, the user D may be determined to be an acquaintance of the user A. It is understood that the determination of friends and acquaintances is explained herein with reference to mobile phone as the user device and moreover the contact information to be a phone number. However, it is understood that other types of user devices and other types of contact information, for example email id, device ID, etc., may be used to facilitate said determination of user friends and acquaintances. In one embodiment, the determination of user friends and acquaintances may be an on-going process.

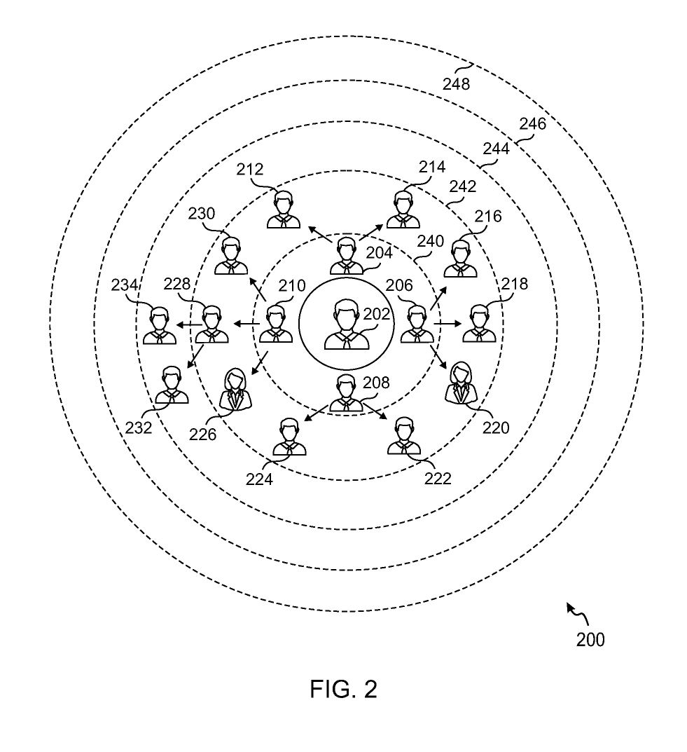

The social interaction platform 106 may further be configured to identify friends and acquaintances of each of those friends and acquaintances of the user. The friends and acquaintances of the user along with friends and acquaintances of those friends and acquaintances constitute, at least in part, the plurality of members of the social network of the user. More specifically, the immediate friends and acquaintances of the user may configure first degree members of the user's social network, whereas friends and acquaintances of the first degree members may configure second degree members of the social network, and so on and so forth. In an embodiment, the social interaction platform 106 may be designed to configure the social network to include members within a pre-defined degree of separation. For example, in an embodiment, the pre-defined degree of separation may be chosen to be five. Accordingly, the social network of the user may be configured to limit a number of members up to a fifth degree of separation (i.e. including members corresponding to the first, second, third, fourth and the fifth degree of separation). An example social network formed by the social interaction platform 106 for a user is explained with reference to FIG. 2.

Referring now to FIG. 2, an example representation of a social network 200 configured for a user 202 by the social interaction platform 106 explained with reference to FIG. 1 is illustrated in accordance with an embodiment of the invention. As explained with reference to FIG. 1, the social interaction platform 106 is configured to form the social network 200 for the user 202 to include first degree members (i.e. immediate contacts and acquaintances) of the user 202 such as users 204, 206, 208 and 210. Further, friends and acquaintances of the users 204, 206, 208 and 210 such as for example, users 212, 214, 216, 218, 220, 222, 224, 226, 228 and 230 form the second degree members. One or more friends and acquaintances of the second degree members, such as exemplary contacts 232 and 234, configure third degree members and so on and so forth.

Furthermore, FIG. 2 depicts a visual representation of the degrees of separation as shown by concentric circles 240, 242, 244, 246 and 248 representing the first, second, third, fourth and fifth degrees of separation, with each degree of separation including a plurality of members. It is understood the social network 200 of the user 202 is depicted herein for illustrative purposes. Moreover, each user within the user's social network may be associated with personal social network such as the social network 200. In many embodiments, each user affiliated/registered with the social networking system 102 may be associated with a personal social network, such as the social network 200. The social interaction platform 106 may further be configured to update the social network of each user in real-time based on member activity related to addition and deletion of related members. For example, if a contact of the user 202, such as for example the user 208, adds a friend to his/her contact list, then that contact may serve as a new second degree contact of the user 202 and a new first degree contact in the social network of the user 208. Similarly, if a member within the user's social network deletes a contact then the change may be appropriately reflected in the social networks of related users.

Referring now to FIG. 1, the social interaction platform 106 is configured to determine a credibility (or trustworthiness) of each user of the social networking system 102 and/or each member of the user's social network. The term ‘credibility’ as used herein refers to trustworthiness associated with a member of the social network vis-à-vis the user. For example, if the credibility of a member in the user's social network is high, then the user may engage in an interaction, for example an interaction related to buy-sell transaction or a question-answer form of interaction, with reasonable confidence that the member (whether at a second degree or a fifth degree of separation) is trustworthy. To that effect, the social interaction platform 106 may set a credibility metric value for each member to a preset value upon his/her initialization (i.e. addition to a social network of a user and/or registration with the social networking system 102, whichever is earlier). The term ‘credibility metric value’ serves as a hypothetical measure of the trust (or trustworthiness of the member). In at least one embodiment, the credibility metric value may be a parameter configured to assume different values on a numerical scale. For example, the credibility metric value for a member may assume any integer value from one to ten, with value of one reflecting lowest credibility and a value of ten reflecting highest credibility.

In at least one embodiment, the social interaction platform 106 is configured to facilitate a change in the credibility metric value from the preset value to another value based on pre-defined criteria. In at least one embodiment, a criterion causing the change in the credibility metric value of a member may relate to any of a frequency of the member's interaction with other members, a number of likes or dislikes received for interaction messages associated with the member, an appropriateness of content of the interaction messages of the member, past interaction history of the member and the like. For example, if a member has been involved in transaction in which the transaction terms were not honored and the other member involved in the transaction has reported such a behavior of the member, then the credibility metric value of the member may be downgraded from its current value. In another illustrative example, if a user has answered a number of queries of other members and the user's responses are well-liked by other members or deemed to be useful, then a credibility metric value of the user may be upgraded from its current value. It is understood that various such user interactions may cause a change in the credibility metric value from its initial preset value. In at least one embodiment, the credibility metric value may be a cumulative effect of various interactions of the member with other members. In at least one embodiment, the social interaction platform 106 is further configured to track, in real-time, the credibility metric value for the each member.

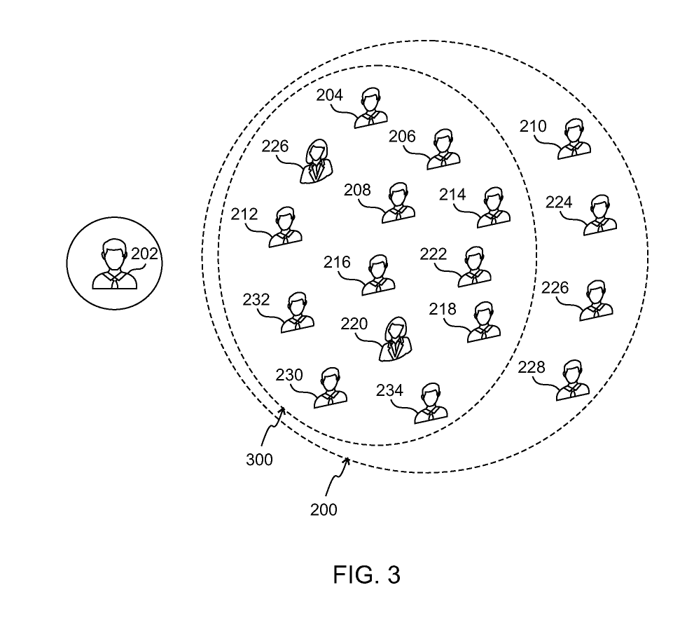

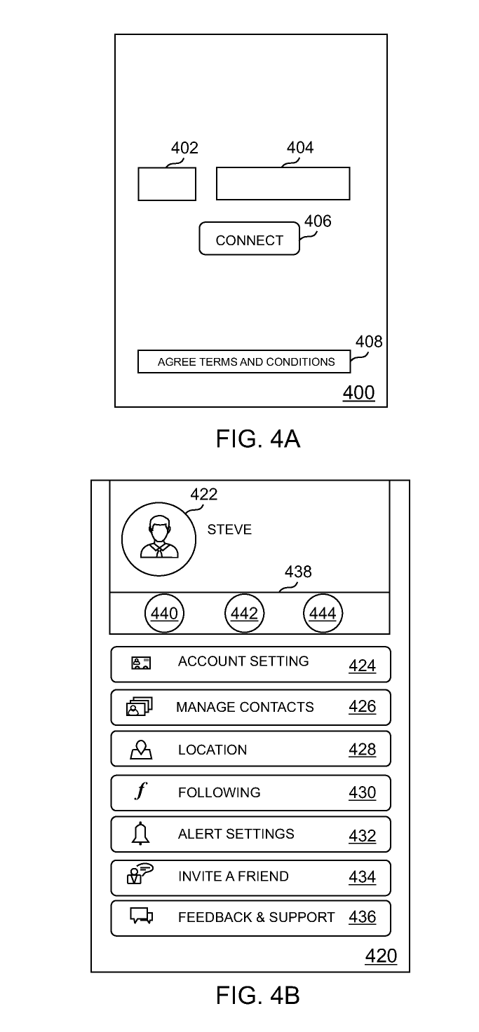

In at least one embodiment, the social interaction platform 106 is caused to receive a user input indicative of user's interest to interact with other members on the social network. In an embodiment, a user interaction with the networking application or provision of user input for invoking the networking application on the user device may provide an indication of user's interest to interact with other members. In another embodiment, the user accessing a message feed for viewing products/services offered for sale by other members or the user accessing a question-answer message feed for viewing questions and answers posted by other members, as will be explained with reference to FIGS. 4A to 10, may provide an indication of user's interest to interact with other members. In yet another embodiment, the user accessing options for posting a question or offering an item or a service for sale to other members of the user's social network may provide an indication of user's interest to interact with other members. In at least one embodiment, the social interaction platform 106 is caused to dynamically create a sub-network of members for the user to interact with upon receiving the user input. The sub-network of users may be dynamically created by pruning one or more members from the user's social network. In at least one embodiment, the social interaction platform 106 may prune members based on the credibility metric value for the each member among other criteria for pruning members. The dynamic creation of the sub-network is further explained with reference to FIG. 3.

Referring now to FIG. 3, an example representation of a sub-network of members created dynamically by the social interaction platform 106 (explained with reference to FIG. 1) upon receiving the user's request is illustrated, in accordance with an embodiment of the invention. As explained with reference to FIG. 2, the social network 200 is formed for the user 202 upon user registration using the networking application on the user device. The social network 200 includes a plurality of members within pre-defined degrees of separation. Further, as explained above, each member of the user's social network is associated with a credibility metric value. In at least one embodiment, the social interaction platform 106, in conjunction with the database 104, is configured to prune members from the user's social network based on their credibility metric values, or more specifically, remove members associated with lower credibility metric values, to create a sub-network of users, with whom the user may interact. For example, in FIG. 3, a sub-network 300 is depicted to be dynamically created from the social network 200 of the user 202 (explained with reference to FIG. 2) by pruning members (such as for example, members 210, 224, 226 and 228) based on the credibility metric value. Such a pruning of members may be performed by the social interaction platform 106 in order to provide the user 202 with a selection of members with whom the user 202 may engage in interactions, such as buy-sell transactions or question-answer based interactions, with a reasonable amount of confidence as the credibility metric values associated with the members in the sub-network is above a threshold of trustworthiness that the user 202 may expect for such interactions.

In addition to the credibility metric value associated with the members of the social network, in some embodiments, the social interaction platform 106 may prune members based on other criteria such as an appropriateness of content of the intended interaction. For example, for an interaction corresponding to a buy-sell transaction for an automobile, the social interaction platform 106 may prune members based on their location co-ordinates (such as for example, prune members within the social network 200 who are located say more than 100 miles away) etc. In another example scenario, the social interaction platform 106 may be configured to prune one or more members from among the plurality of members associated with the social network based on specific content corresponding to user's interaction message included in the user input. For example, the social interaction platform 106 may be configured to prune one or more members based on appropriateness of content related to age, gender, professional activity and the like. It is noted that the sub-network 300 is configured dynamically or in real-time by pruning members based on various criteria as explained above for enabling the user 202 to interact with credible people in a convenient manner. Moreover, it is understood that configuring a social network of members known to the user either through direct contact or indirectly through known contacts adds a certain amount of credibility to the interactions conducted amongst the members. The pruning of members within such a social network further safeguards the user from any potential negative experience during his/her social interactions.

As explained above, the user 202 may interact with other members in the sub-network 300 to request an availing of a product or a service, to offer for sale an item or a service, to request answers to a query or to answer queries of other members in the sub-network 300. In at least one embodiment, interaction messages from one or more members corresponding to the sub-network 300 are displayed by the networking application on the user device. The networking application and social interaction between the user and other members of the sub-network 300 is explained further with reference to FIGS. 4A-10.

Referring now to FIG. 4A, a diagram illustrating an example representation of a first user interface (UI) 400 presented to a user on a user device upon accessing the networking application is shown, in accordance with an embodiment of the invention. As explained with reference to FIG. 1, a networking application may be provisioned to the user device upon receipt of a user request by the social interaction platform 106. The user may request for a download of the networking application using an application store on the user device which may in turn request the social interaction platform 106 to provision the networking application to the user device. Upon provisioning of the networking application on the user device, the user may access the networking application on the user device. The user may click/tap on an icon associated with the networking application displayed on a display screen of the user device to access the networking application. In at least one example embodiment, the first UI 400 (hereinafter referred to as UI 400) may be presented to the user on the display screen of the user device upon accessing of the networking application.

As can be seen in FIG. 4A, the UI 400 depicts a plurality of text boxes, such as for example text boxes 402 and 404, configured to receive numerical input corresponding to a country code and a phone number associated with the user device, respectively. The user may provide appropriate input (for example, by manually typing the digits or by selecting from auto-fill options) and clicking/tapping a ‘CONNECT’ operator 406 in order to login into the networking application. In some embodiments, for a first time access, the user may have to click/tap on an operator 408 for providing acceptance of applicable terms and conditions for accessing the networking application. It is understood that such a manner of logging in into the networking application is described herein for illustration purposes and that the user may login into the application in many different ways. For example, the UI 400 may display text boxes capable of receiving textual input corresponding to a user name and a password or even profile related information for logging into the networking application. In at least one embodiment, the information provided by the user during login using the networking application may be authenticated by the social interaction platform 106 using information stored corresponding to the user in the database 104. Upon authentication, the user may be provided with a second UI as will be explained with reference to FIG. 4B.

Referring now to FIG. 4B, a diagram illustrating an example representation of a second UI 420 presented to the user on the user device by the networking application upon user login is shown, in accordance with an embodiment of the invention. In at least one embodiment, the second UI 420 (hereinafter referred to as UI 420) serves as an application home screen corresponding to the networking application.

In an embodiment, the UI 420 depicts an image portion 422, which is configured to display an image provided by the user. The provided image may serve as the profile picture of the user and may be displayed to other members of the user's social network along with any interaction message (for example, any transaction related message or even a question or an answer posted by the user using the networking application). In at least one embodiment, a user's name may be depicted substantially adjacent to the image portion 422. In the UI 420, the user's name is exemplarily depicted to be ‘STEVE’.

The UI 420 further depicts a number of menu labels, for example menu labels 424, 426, 428, 430, 432, 434 and 436 displaying text ‘ACCOUNT SETTINGS’, ‘MANAGE CONTACTS’, ‘LOCATION’, ‘FOLLOWING’, ‘ALERT SETTINGS’, ‘INVITE A FRIEND’ AND ‘FEEDBACK AND SUPPORT’, respectively. The menu labels 424, 426, 428, 430, 432, 434 and 436 are configured to enable the user to access settings of the user's account, to manage contacts, to set/change location information, to view information related to members followed by the user or members following the user, to alert the user of new interaction messages or addition/deletion of members, to invite a friend and to provide feedback or request support, respectively. It is understood that the UI 420 is depicted for illustration purposes and that UI display presented to the user upon login may include different labels than those depicted in the UI 420. Furthermore, the UI 420 may be configured to display widgets (for example a search widget) or infographics in addition to the labels displayed on the UI 420.

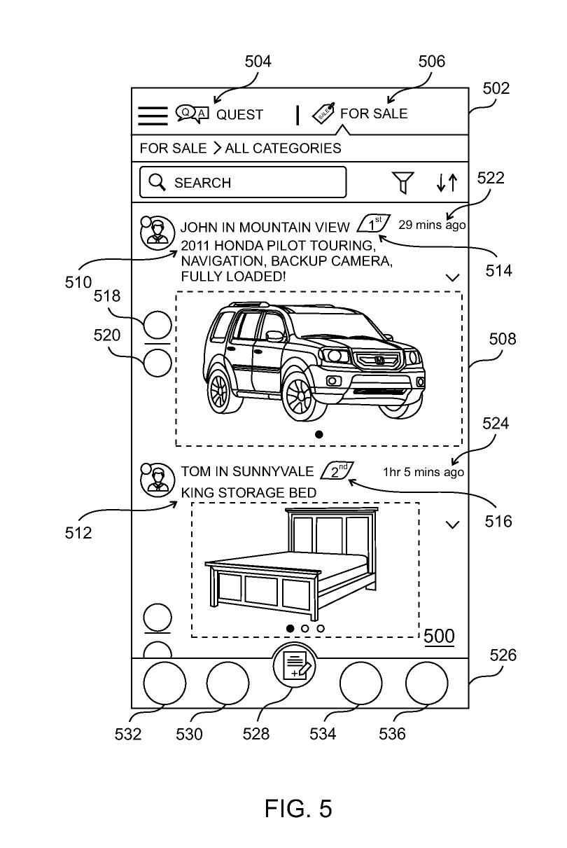

In at least one embodiment, the UI 420 may be configured to depict a profile summary section 438 which may provide a snapshot of important information associated with the user account. For example, the profile summary section 438 may display icons, such as icons 440, 442 and 444, which may be configured to display numbers, such as for example, a number of members in the user's social network, a number of unread interaction messages, a number of questions or answers posted within a preset time-frame by members within the user's social network and the like. In at least one embodiment, the user may be presented with another UI upon the user tapping/clipping on the profile summary section 438. Such an UI is explained with reference to FIG. 5.

Referring now to FIG. 5, a diagram illustrating an example representation of a third UI 500 presented to the user on the user device is shown, in accordance with an embodiment of the invention. In at least one embodiment, the third UI 500 (hereinafter referred to as UI 500) is configured to depict, in a first display portion 502, a first menu label 504 and a second menu label 506. The first menu label 504, upon user selection, may facilitate display of a UI showing interaction messages related to questions and answers posted by various other users in a sub-network of the user, such as the sub-network 300 explained with reference to FIG. 3. The second menu label 506 may be associated with a UI, such as the UI 500, showing a message feed related to products and/or services offered for sale by other members within the sub-network of the user. More specifically, the UI 500 includes a second display portion 508 configured to display interaction messages or posts related to products or services on offer for sale from other members within the user's sub-network. The second display portion 508 displays two such interaction messages (also referred to as posts) 510 and 512. As an illustrative example, the post 510 is depicted to be a message related to sale of an automobile posted by a member from among the members within the sub-network of the user. Similarly, the post 512 is depicted to be a message related to sale of household furniture posted by another member from among the members within the sub-network of the user.

Each post includes information related to the member associated with the interaction message. For example, the post 510 depicts a member name, exemplarily depicted to be John, along with an image of John (for example, the profile image of John) and a relationship degree indicator configured to assist a user in identifying a degree of separation between the user and the member. For example, a relationship degree indicator 514 associated with John indicates that John is a first-degree contact (i.e. a friend or an acquaintance) of the user. Similarly, the post 512 depicts a member name, exemplarily depicted to be Tom, along with an image of Tom (for example, the profile image of Tom) and a relationship degree indicator 516 depicting ‘2^{nd}’, indicating that Tom is a second-degree contact (i.e. a friend or an acquaintance of a first-degree contact) of the user. Further, each post may include options, such as options 518 and 520 for following the post and for sharing the post on one or more other social networking mediums, respectively. Each post may also be associated with a timestamp, such as timestamps 522 and 524, associated with the posts 510 and 512, respectively.

Further, the UI 500 depicts a third display portion 526 configured to depict a plurality of menu icons, such as icons 528, 530, 532, 534 and 536 configured to enable the user to input an interaction message/post for offering an item or a service for sale, to view all previous interaction messages posted by the user, to view favorite interaction messages marked by the user, to view previous chat conversations with other members and to view alerts set by the user, respectively. It is understood that such a selection of menu icons is described herein for illustration purposes and the UI 500 may include fewer or more number of menu icons than those described herein.

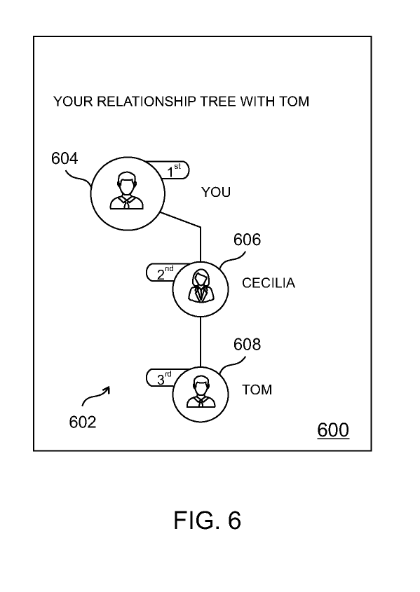

In at least one embodiment, the networking application may be configured to present a user with a visual representation of how the user is related with a member associated with a post. For example, the user may tap or click on the relationship degree indicator 516 to view a relationship chain or link between the user and Tom. An example visual representation presented to the user upon accessing the relationship degree indicator is depicted in FIG. 6.

FIG. 6 shows a diagram illustrating an example representation of a fourth UI 600 presented to the user on the user device, in accordance with an embodiment of the invention. As explained with reference to FIG. 5, a visual representation is presented to the user upon clicking/tapping a relationship degree indicator for depicting how the user is related with the member associated with an author of a post. In an embodiment, the fourth UI 600 (hereinafter referred to as UI 600) is presented to the user upon clicking or tapping the relationship degree indicator 516 corresponding to the post 512 by Tom. The UI 600 depicts a visual representation of the user's relationship with Tom in form of a relationship tree 602. The relationship tree 602 depicts the user as ‘You’ at a first node 604 along with a symbol ‘1^{st}’ indicating a relationship of the user with self. Further, the relationship tree 602 depicts a user's relationship with ‘CECILIA’ by using a symbol ‘2^{nd}’ at node 606 and the user's relationship with ‘TOM’ is depicted by using a symbol ‘3^{rd}’, sign at node 608. It is noted that the symbols ‘2^{nd}’ and ‘3^{rd}’ depicted in the relationship tree 602 imply that Cecilia is a first degree contact (or a direct contact) of the user and Tom is a second degree contact of the user (i.e. the user is connected to the Tom through Cecilia), respectively. It is understood that the visual representation of how a user is connected to the author of the post is shown here as a relationship tree for illustration purposes. Indeed various such implementations may be envisioned to enable the user to visualize a user's relationship with an author of a post in the message feed of the networking application.

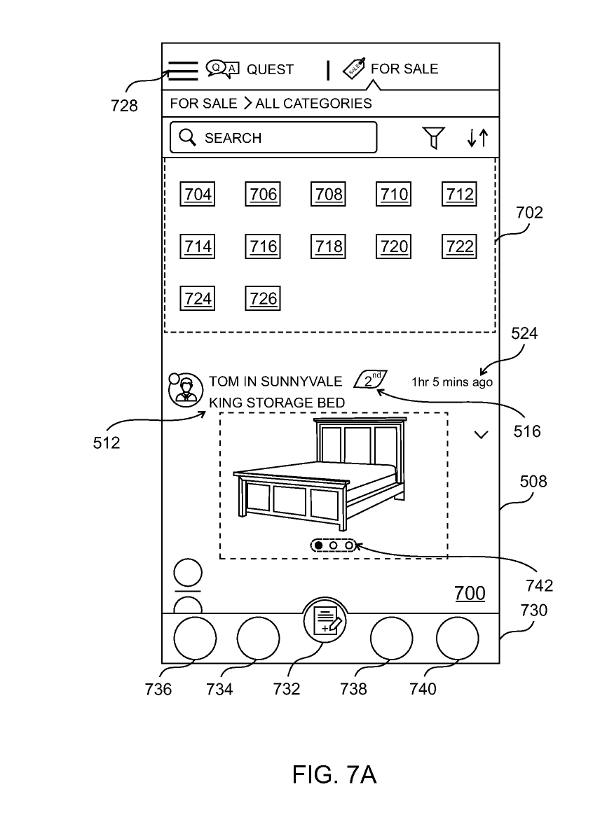

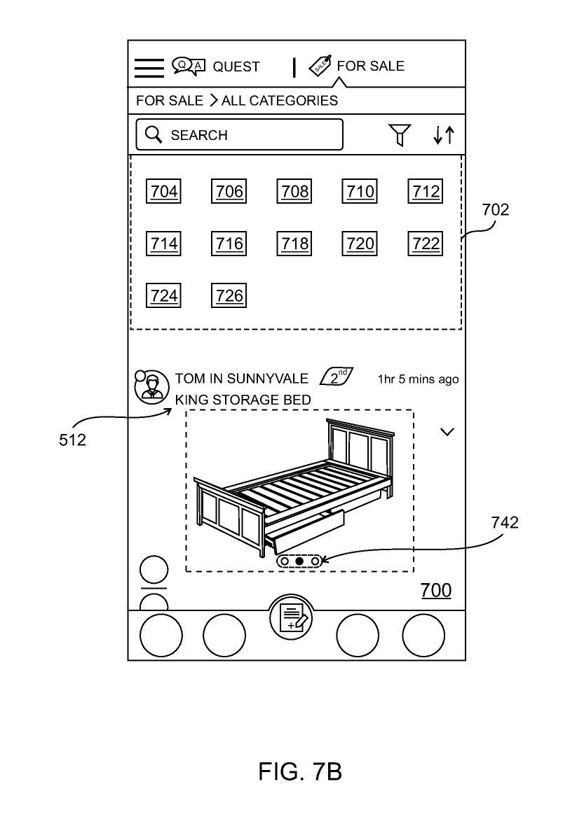

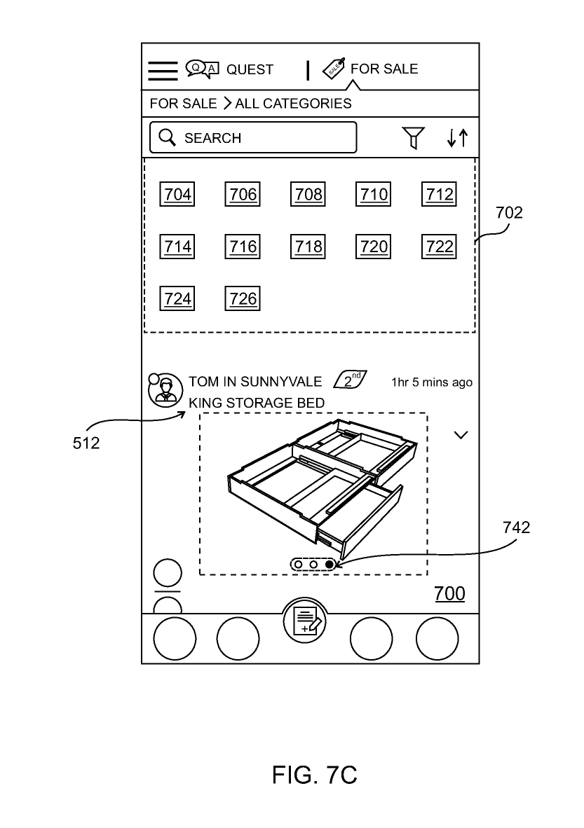

FIG. 7A shows a diagram illustrating an example representation of a fifth UI 700 displaying a plurality of categories to enable a user to customize a message feed of interaction messages, in accordance with an embodiment of the invention. As explained with reference to FIG. 5, a user may view messages or posts related to products or services on offer for sale in his/her message feed upon logging into the networking application. A message feed related to the products or services on offer for sale by other members in the sub-network of the user is depicted using the UI 500. In at least one embodiment, the social interaction platform 106 explained with reference to FIG. 1 may be configured to classify interaction messages from various members associated with the social interaction platform 106 into a plurality of pre-defined categories. Non-exhaustive examples of the pre-defined categories may include categories for electronic devices and gadgets, automobiles, baby care, pet care, household help, food items, cooking recipes, home decoration and furniture, books, music, pets, sports and health, movie tickets and the like. Further, the social interaction platform 106 may be configured to provision a category selection option to the user upon user access of the networking application as depicted in the fifth UI 700 (hereinafter referred to as UI 700). More specifically, the UI 700 is a modified representation of the UI 500 where in addition to the first display portion 502 (explained with reference to the UI 500), a category selection menu 702 is presented to the user on the user device.

As an illustrative example, the category selection menu 702 displays categories 704-726 corresponding to various pre-defined categories. A user may select a desired category in order to view messages related to the chosen category in the same message feed. In at least one example embodiment, the second display portion 508 of the UI 500 is configured to expand and collapse based on user selection of a category from among the pre-defined categories to enable the user to view related interaction messages without navigating to different UIs. For example, a selection of a home decoration and furniture category from among the displayed categories in the category selection menu 702 may configure a message feed in the second display portion 508 to display only messages like the post 512 in the message feed. In such a scenario, the user does not have to navigate to a different UI to view messages from desired category and can view the desired messages within the same UI, such as the UI 700 itself. In at least one example embodiment, the category selection menu 702 may be presented to the user upon selection on a menu operator 728. Alternatively, the user may trace a downward swipe to access the category selection menu 702. It is understood that invoking of the category selection menu 702 may not be limited to the techniques suggested herein. Indeed the category selection menu 702 may be invoked in many different ways.

Further, the UI 700 may also display a plurality of menu icons, in a display portion 730, such as icons 732, 734, 736, 738 and 740 similar to the icons 528, 530, 532, 534 and 536 explained with reference to the UI 500 in FIG. 5. A user may access the icon 732 for invoking a UI configured to enable the user to input a new interaction message or a post for offering an item or a service for sale such as the post 512 depicted in the UI 700.

In at least one example embodiment, the networking application is configured to facilitate a sideways scrolling display for each interaction message in the message feed to enable the user to view additional information related to the interaction message on the same UI. For example, if the post 512 is associated with additional information on the storage bed being sold, such as for example information related to a quality of wood, a number of storage compartments etc., then the user may swipe the post 512 to the left, for example by using a finger or a thumb input, to view such additional information. In an embodiment, the presence of additional information related to interaction message may be indicated to the user using a supplementary information bar 742. The supplementary information bar 742 may include a number of indicators, indicative of a number of views of additional information related to the same interaction message 512. For example, the supplementary information bar 742 is depicted to display three indicators indicating three views (including current view) corresponding to the interaction message 512. Since the first view of the interaction message 512 is being viewed, the first indicator in the supplementary information bar 742 is highlighted. Upon sideways scrolling, for example by using a thumb/finger input, a second view corresponding to the interaction message 512 may be displayed to the user as depicted in FIG. 7B. As can be seen in FIG. 7B, the second indicator is highlighted in the supplementary information bar 742, whereas the first indicator is reset to its un-highlighted form. Upon further sideways scrolling by the user, a third view corresponding to the interaction message 512 may be displayed to the user as depicted in FIG. 7C. As can be seen in FIG. 7C, the third indicator is highlighted in the supplementary information bar 742, whereas the second indicator is reset to its un-highlighted form. Such a navigation facility enables a user to view all information related to various member posts, on the same UI, i.e. the fifth UI 700 itself, without having to navigate to and fro between various UIs to view information on various products/services on offer for sale.

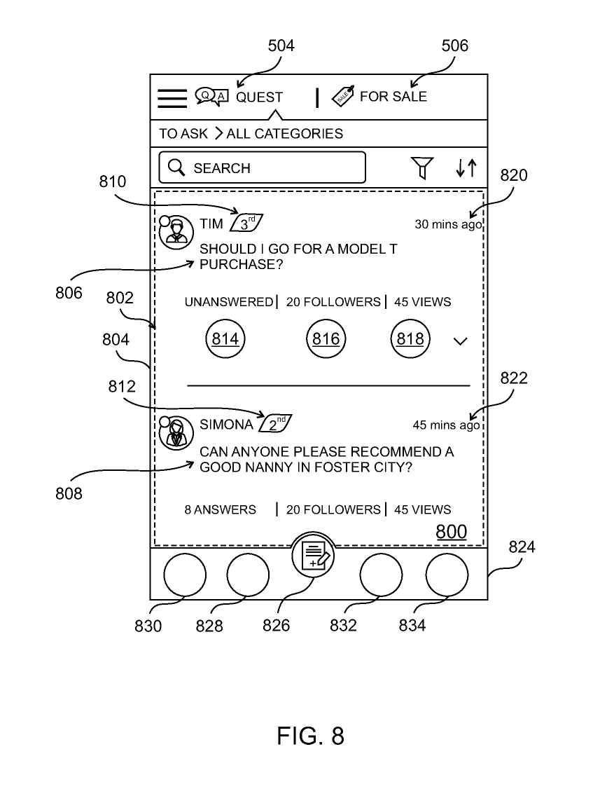

FIG. 8 shows a diagram illustrating an example representation of a sixth UI 800 presented to the user for viewing a message feed related to questions and answers being exchanged among various members in the sub-network of users, in accordance with an embodiment of the invention. As explained with reference to the UI 500 in FIG. 5, a user may view a message feed of interaction messages or posts related to products or services on offer for sale by other members in the sub-network of the user. Further, the user may select the first menu label 504 depicted on the UI 500 to access another message feed 802 related to questions and answers exchanged among other members of the sub-network of the user.

More specifically, the sixth UI 800 (hereinafter referred to as UI 800) includes a first display portion 804 configured to display the message feed 802 including interaction messages or posts related to questions and answers exchanged among other members of the sub-network of the user. The first display portion 804 displays two such interaction messages (or posts) 806 and 808. As can be seen from the message feed 802 displayed on the UI 800, members may post questions related to various topics, such as for example, ‘Can anyone please recommend a good nanny in Foster City?’ or ‘Should I go for a Model T purchase?’ As can be seen the questions may range from various topics and since the sub-network comprises members that the user can trust, the answers to the questions are most likely to be helpful to the members requesting answers to their queries.

Each post includes information related to the member associated with the interaction message. For example, the post 806 depicts a member name, exemplarily depicted to be ‘TIM’, along with an image of Tim (for example, the profile image of Tim) and a relationship degree indicator configured to assist a user in identifying a degree of separation between the user and the member. For example, the relationship degree indicator 810 associated with Tim indicates that Tim is a third-degree contact (i.e. a friend or an acquaintance) of the user. Similarly, the post 808 depicts a member name, exemplarily depicted to be ‘SIMONA’, along with an image of Simona (for example, the profile image of Simona) and a relationship degree indicator 812 depicting ‘2^{nd}’, indicating that Simona is a second-degree contact (i.e. a friend or an acquaintance of a first-degree contact) of the user. Further, each post may include options, such as options 814, 816 and 818 for bookmarking the post as a favorite, for following the post and for sharing the post on one or more other social networking mediums, respectively. Each post may also be associated with a timestamp, such as timestamps 820 and 822, associated with the posts 806 and 808, respectively.

In at least one example embodiment, the user may also be presented with a category selection menu, such as the category selection menu 702 explained with reference to FIG. 7, in order to customize the message feed 802 to reflect messages related to desired category. The customization in form of expansion and collapse of the message feed 802 based on selection of a category from among the pre-defined categories to enable the user to view related interaction messages without navigating to different UIs may be performed as explained with reference to FIG. 7 and is not explained again herein. Further, the networking application may be configured to facilitate sideways scrolling display for each interaction message in the message feed 802 to enable the user to view additional information related to the displayed questions without navigating to different UIs. More specifically, a user may view various answers (or for example top ranked answers) provided by other members of the network corresponding to a question by swiping the interaction message, for example towards the left. The user may then scroll back to the question by swiping display portions corresponding to the interaction message to the right. Such sideways scrolling enables to view all information related to a post on the same UI, for example the UI 800, itself.

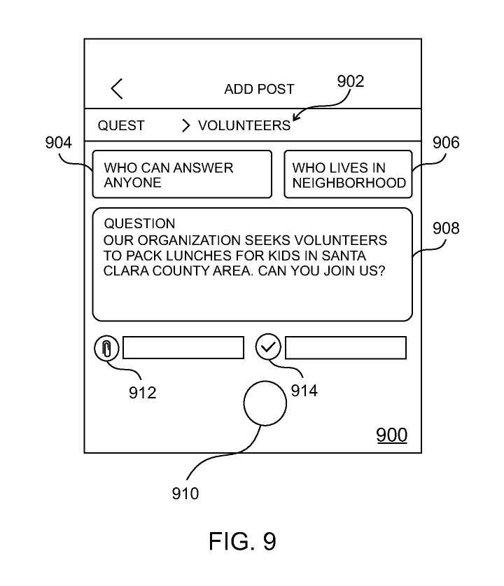

The UI 800 further includes a second display portion 824 configured to display a plurality of menu icons, such as icons 826, 828, 830, 832 and 834 configured to enable the user for inputting a user query, to view all previous questions and/or answers posted by the user, to view favorite questions and/or answers marked by the user, to view previous chat conversations with other members and to view alerts set by the user, respectively. It is understood that such a selection of menu icons is described herein for illustration purposes and the UI 800 may include fewer or more number of menu icons than those described herein. A UI presented to the user upon user access of the icon 826 is explained with reference to FIG. 9.

FIG. 9 shows a diagram illustrating an example representation of a seventh UI 900 presented to the user for enabling the user to post an interaction message for display to other members of the user's social network, in accordance with an embodiment of the invention. The seventh UI 900 (hereinafter referred to as UI 900) depicts a selection 902 of a category ‘VOLUNTEERS’ for classifying the question being posted by the user. In an example embodiment, the user may choose an appropriate category from among various pre-defined categories explained with reference to FIGS. 7A-7C for a question that the user desires to put forth to various other members. It is understood that the choice of the category ‘VOLUNTEERS’ is depicted herein for illustration purposes only.

Further, the UI 900 depicts a plurality of text boxes, such as text boxes 904, 906 and 908 configured to enable the user to select who can answer the question, to select a choice of location for members likely to answer the question and to input information about the question itself, respectively. For example, in an illustrative scenario, the user may choose an option ‘ANYONE’ in text box 904 to indicate a user's choice that anyone associated with the social networking system 102 (explained with reference to FIG. 1) may answer the question. It is understood that in some scenarios, the user may want to interact with even members who are not a part of the sub-network or the social network of the user, such as for example, in scenarios involving social causes. For example, in a scenario, where the user would want volunteers for a social cause, the user may seek a wider audience and accordingly choose to address the question to all members associated with the social networking system 102. In another illustrative scenario, the user may choose a location preference as ‘WHO LIVES IN NEIGHBORHOOD’ in text box 906 to read in conjunction with user input in the text box 904, thereby indicating ‘anyone who lives in the user's neighborhood’ and who is associated with the social networking system 102 may answer the question.

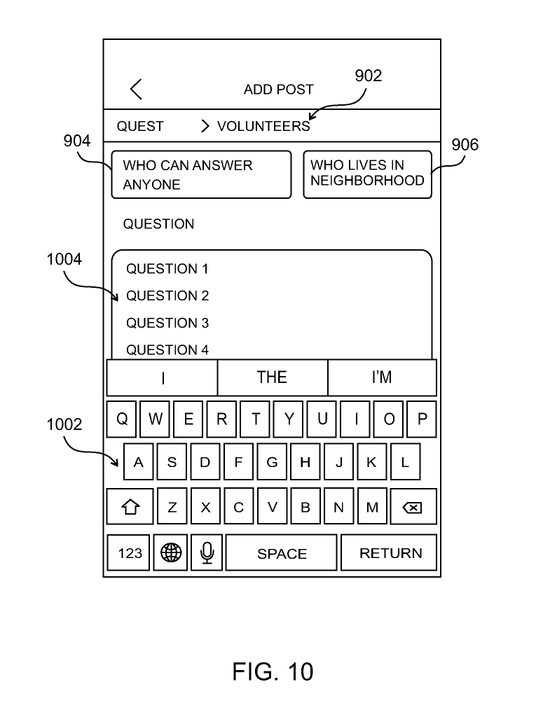

The user may input the question in the text box 908. For example, the user may input a question, such as, ‘Our organization seeks volunteers to pack lunches for kids in Santa Clara county area. Can you join us?’ Upon such an input of the question, the user may access an actuation operator 910 to post the question as an interaction message to the intended audience as chosen using options in the text boxes 904 and 906. In some embodiments, the user may be provided with a virtual keyboard such as a virtual keyboard 1002 shown in FIG. 10 to assist the user to provide the textual input corresponding to the question. Further, as the user initiates typing, one or more question templates 1004 exemplarily depicted to include four questions as ‘QUESTION 1’, ‘QUESTION 2’, ‘QUESTION 3’, ‘QUESTION 4’ etc., in FIG. 10 may be provisioned to further assist the user in providing the textual input corresponding to the question. The questions may not only serve as a template for the user to provide his input but in many example scenarios, the questions draw the user's attention to the same question or related questions input by other members in the user's network, which may be very helpful for the user. In some example scenarios, the user upon being informed of a similar question being posted by a familiar member within the user's network may pool in resources to achieve a wider impact and so on and so forth.

Referring now to FIG. 9, in some embodiments, the UI 900 may further present options such as options 912 and 914 configured to enable the user to attach an image and post the question as an anonymous user, respectively. It is noted that the UI 900 including various options to facilitate user input of a question, or even an answer to a question, are depicted herein for example purposes and may not be considered to be limiting the scope of the invention.

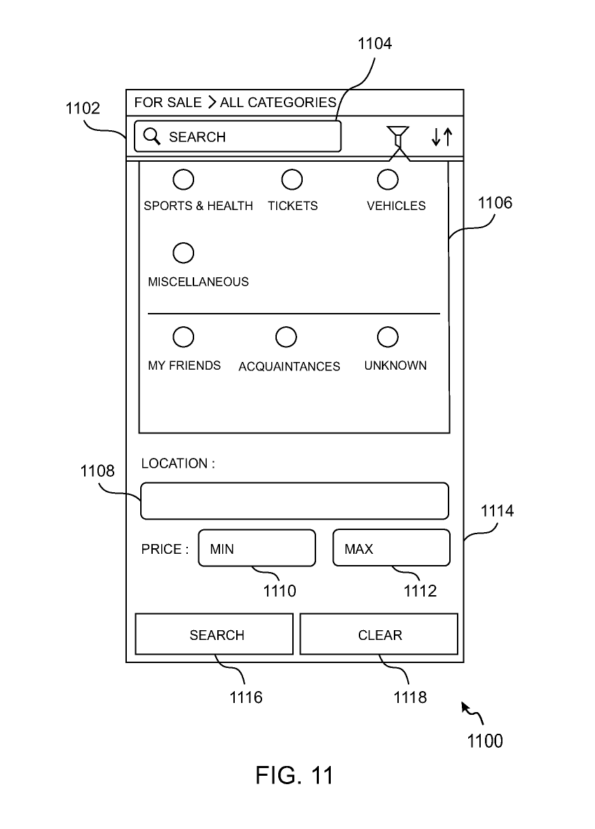

Referring now to FIG. 11, a diagram illustrating an example representation of an eighth UI 1100 presented to the user for enabling the user to search for desired information is shown, in accordance with an embodiment of the invention. The eighth UI 1100 (hereinafter referred to as UI 1100) is configured to display, in a first display portion 1102, a search box 1104 configured to receive textual input corresponding a user search query. Further, the UI 1100 is configured to display, in a second display portion 1106, selectable options for choosing categories to search and retrieve interaction messages corresponding to the search query provided by the user in the search box 1104. The second display portion 1106 is depicted to exemplarily display selectable options for categories related to ‘SPORTS AND HEALTH’, ‘TICKETS’, ‘VEHICLES’ AND ‘MISCELLANEOUS’ categories. The UI 1100 is further configured to display, in the second display portion 1106, selectable options for searching people corresponding to the search query provided by the user in the search box 1104. The second display portion 1106 is depicted to exemplarily display selectable options for searching among ‘MY FRIENDS’, ‘ACQUAINTANCES’ and ‘UNKNOWNS’ (or strangers).

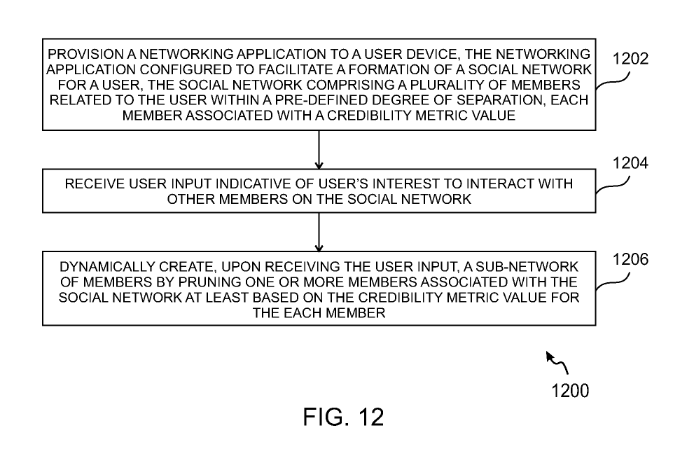

The UI 1100 may further facilitate in limiting a number of search results retrieved by the networking application by restricting the search based on location and price criteria. To that effect, the user may provide appropriate input for location in text box 1108 and for a minimum price in text box 1110 and a maximum price in text box 1112 displayed in a third display portion 1114. The user may provide appropriate selections in the second and third display portions upon entering input in the search box 1104 and proceed to actuate the search by accessing the search operator 1116 (exemplarily depicted to be associated with textual label ‘SEARCH’). Alternatively, the user may clear all search parameters by accessing the clear search parameter operator 1118 (exemplarily depicted to be associated with textual label ‘CLEAR’). A method for facilitating social interactions of users is hereinafter explained with reference to an example method in FIG. 12.

FIG. 12 illustrates a flow diagram of an example method 1200 for facilitating user social interactions, in accordance with an example embodiment. The method 1200 depicted in the flow diagram may be executed by, for example, a social networking system 102 explained with reference to FIGS. 1 to 11. Operations of the flowchart, and combinations of operation in the flowchart, may be implemented by, for example, hardware, firmware, a processor, circuitry and/or a different device associated with the execution of software that includes one or more computer program instructions. The operations of the method 1200 may be executed by the social networking system 102. For example, one or more operations corresponding to the method 1200 are explained may be executed by the social interaction platform 106 of the social networking system 102. It is also noted that, the operations of the method 1200 can be described and/or practiced by using a system other than the social networking system 102.

At operation 1202, a networking application is provisioned to a user device (for example, by a social interaction platform, such as the social interaction platform 106 explained with reference to FIG. 1). The networking application is configured to facilitate, upon user registration, a formation of a social network for a user. The user registration onto the networking application may be performed as explained with reference to FIG. 4A and the formation of the social network may be performed as explained with reference to FIGS. 1 and 2. The social network includes a plurality of members related to the user within a pre-defined degree of separation. The social network may further be updated in real-time based on member activity related to addition and deletion of related members as explained with reference to FIG. 2.

Further, as explained with reference to FIG. 2, each member is associated with a credibility metric value. The term ‘credibility’ refers to trustworthiness associated with a member of the social network vis-à-vis the user. For example, if the credibility of a member in the user's social network is high, then the user may engage in an interaction, for example an interaction related to buy-sell transaction or a question-answer form of interaction, with reasonable confidence that the member (whether at a second degree or a fifth degree of separation) is trustworthy. To that effect, credibility metric value for each member may be set to a preset value upon his/her initialization with the social interaction platform. The term ‘credibility metric value’ serves as a hypothetical measure of the trust (or trustworthiness of the member). In at least one embodiment, the credibility metric value may be a parameter configured to assume different values on a numerical scale. For example, the credibility metric value for a member may assume any integer value from one to ten, with value of one reflecting lowest credibility and a value of ten reflecting highest credibility.

Further, a change in the credibility metric value from the preset value to another value may be facilitated based on pre-defined criteria. In at least one embodiment, a criterion causing the change in the credibility metric value of a member may relate to any of a frequency of the member's interaction with other members, a number of likes or dislikes received for interaction messages associated with the member, an appropriateness of content of the interaction messages of the member, past interaction history of the member and the like. The criteria causing change in the credibility metric value are explained with reference to FIG. 2 and are not explained again herein. In at least one embodiment, the credibility metric value for the each member is tracked, in real-time, by the social interaction platform.

At operation 1204, user input indicative of user's interest to interact with other members on the social network is received. In an embodiment, a user interaction with the networking application or provision of the user input for invoking the networking application on the user device may provide an indication of user's interest to interact with other members. In another embodiment, the user accessing a message feed for viewing products/services offered for sale by other members or the user accessing a question-answer message feed for viewing questions and answers posted by other members, as explained with reference to FIG. 8, may provide an indication of user's interest to interact with other members. In yet another embodiment, the user accessing options for posting a question or offering an item or a service for sale to other members of the user's social network may provide an indication of user's interest to interact with other members.

At operation 1206, a sub-network of members is dynamically created for the user to interact with upon receiving the user input. The sub-network of users may be dynamically created by pruning one or more members from the user's social network. In at least one embodiment, the social interaction platform may prune members based on the credibility metric value for the each member among other criteria for pruning members. In addition to the credibility metric value associated with the members of the social network, in some embodiments, the social interaction platform may prune members based on other criteria based on an appropriateness of content of the intended interaction. The dynamic creation of the sub-network may be facilitated as explained with reference to FIG. 3 and is not explained herein.

As explained with reference to FIG. 3, such a pruning of members may be performed by the social interaction platform in order to provide the user with a selection of credible members with whom the user may engage in interactions. The user may then interact with other members in the sub-network to request an availing of a product or service, to offer for sale an item or a service, to request answers to a query or to answer queries of other members in the sub-network. In at least one embodiment, interaction messages from one or more members corresponding to the sub-network are displayed by the networking application on the user device as explained with reference to FIGS. 5 to 11.

Without in any way limiting the scope, interpretation, or application of the claims appearing below, advantages of one or more example embodiments disclosed herein include providing a user with a selection of members with whom the user may engage in interactions, such as buy-sell transactions or question-answer based interactions, with a reasonable amount of confidence. Since the members of the sub-network are related to the user, either directly or through the user's contacts, a trust component in such interactions is substantially higher than compared to engaging in a transaction or receiving an answer to an important question from a complete stranger. Further, techniques suggested herein update the member network as well as track their credibility metric values, in real-time, thereby presenting users with an up-to-date selection of members to interact with. The various features of the networking application as described herein further enable the user to interact with credible people in a convenient manner.

Although the present invention has been described with reference to specific exemplary embodiments, it is noted that various modifications and changes may be made to these embodiments without departing from the broad spirit and scope of the present invention. For example, the various operations, blocks, etc., described herein may be enabled and operated using hardware circuitry (for example, complementary metal oxide semiconductor (CMOS) based logic circuitry), firmware, software and/or any combination of hardware, firmware, and/or software (for example, embodied in a machine-readable medium). For example, the systems and methods may be embodied using transistors, logic gates, and electrical circuits (for example, application specific integrated circuit (ASIC) circuitry and/or in Digital Signal Processor (DSP) circuitry).

Various embodiments of the present invention, as discussed above, may be practiced with steps and/or operations in a different order, and/or with hardware elements in configurations which are different than those which are disclosed. Therefore, although the technology has been described based upon these exemplary embodiments, it is noted that certain modifications, variations, and alternative constructions may be apparent and well within the spirit and scope of the technology. Although various exemplary embodiments of the present invention are described herein in a language specific to structural features and/or methodological acts, the subject matter defined in the appended claims is not necessarily limited to the specific features or acts described above. Rather, the specific features and acts described above are disclosed as exemplary forms of implementing the claims.

What is claimed is:

1. A computer-implemented method of operating a social networking system comprising:
provisioning a networking application to a user device, the networking application configured to facilitate, upon user registration, a formation of a social network for a user, the social network comprising a plurality of members related to the user within a pre-defined degree of separation, each member from among the plurality of members associated with a credibility metric value;
receiving user input indicative of user's interest to interact with other members on the social network; and
dynamically creating a sub-network of members for the user to interact with upon receiving the user input, the sub-network of members created by pruning one or more members from among the plurality of members associated with the social network at least based on the credibility metric value for the each member.

2. The method of claim 1, further comprising:
setting the credibility metric value for the each member to a preset value upon initialization of the each member;
facilitating a change in the credibility metric value from the preset value to another value based on pre-defined criteria; and
tracking, in real-time, the credibility metric value for the each member to facilitate dynamic creation of the sub-network of members for the user.

3. The method of claim 2, wherein at least one criterion from among the pre-defined criteria for causing the change in the credibility metric value of a member relates to a frequency of interaction of the member, a number of likes or dislikes received for interaction messages associated with the member, an appropriateness of content of the interaction messages and past interaction history of the member.

4. The method of claim 1, wherein the plurality of members related to the user at least comprises friends and acquaintances of the user.

5. The method of claim 1, further comprising:
updating the social network of the user in real-time based on member activity related to addition and deletion of related members.

6. The method of claim 1, further comprising:
displaying on the user device, by the networking application, interaction messages from at least one member from among the sub-network of members, wherein at least one interaction message from among the interaction messages relates to a request for availing a product or a service, an offer to sell an item or a service, a query for other members and an answer to a member query.

7. The method of claim 6, wherein the interaction messages are classified based on pre-defined categories, and, wherein the pre-defined categories comprise categories related to at least one of electronic devices and gadgets, automobiles, baby care, pet care, household help, food items, cooking recipes and travel.

8. The method of claim 7, wherein a display portion of a user interface (UI) corresponding to the displayed interaction messages is configured to expand and collapse based on a user selection of a category from among the pre-defined categories to enable the user to view related interaction messages on the same UI.

9. The method of claim 8, further comprising:
facilitating a sideways scrolling display for each interaction message from among the interaction messages to enable the user to view additional information related to the each interaction message on the same UI.

10. The method of claim 1, further comprising:
facilitating the pruning of the one or more members from among the plurality of members associated with the social network based on specific content corresponding to the user's interaction message included in the user input.

11. The method of claim 1, wherein the user device is a mobile phone storing contact information of a plurality of user contacts, the mobile phone associated with a phone number.

12. The method of claim 11 further comprising performing for a user contact from among the plurality of user contacts:
determining if the user contact is associated with the networking application; and
performing, upon determining the user contact to be associated with the networking application, one of:
determining the user contact to be a friend of the user if the user contact has stored the phone number in a device associated with the user contact; and
provisioning a friend request to the user contact if the user contact has not stored the phone number in the device.

13. A social networking system comprising:
a database; and
a social interaction platform in operative communication with the database, the social interaction platform communicably associated with a plurality of user devices and capable of provisioning a networking application to each user device from among the plurality of user devices, the networking application in conjunction with the social interaction platform configured to facilitate, upon user registration, a formation of a social network for a user of a user device, the social network comprising a plurality of members related to the user within a pre-defined degree of separation, each member from among the plurality of members associated with a credibility metric value,
wherein the social interaction platform is configured to receive user input indicative of user's interest to interact with other members on the social network and dynamically create a sub-network of members for the user to interact with upon receiving the user input, the sub-network of members created by pruning one or more members from among the plurality of members associated with the social network at least based on the credibility metric value for the each member.

14. The system of claim 13, wherein the social interaction platform is caused to:
set the credibility metric value for the each member to a preset value upon initialization of the each member;
facilitate a change in the credibility metric value from the preset value to another value based on pre-defined criteria; and
track, in real-time, the credibility metric value for the each member to facilitate dynamic creation of the sub-network of members for the user.

15. The system of claim 13, wherein the plurality of members related to the user at least comprises friends and acquaintances of the user and contacts of those friends and acquaintances.

16. The system of claim 13, wherein the social interaction platform is configured to update the social network of the user in real-time based on member activity related to addition and deletion of related members.

17. The system of claim 13, wherein the user device is a mobile phone storing contact information of a plurality of user contacts, the mobile phone associated with a phone number.

18. The system of claim 17, wherein the social interaction platform is configured to perform for a user contact from among the plurality of user contacts:
determine if the user contact is associated with the networking application; and
perform, upon determining the user contact to be associated with the networking application, one of:
determine the user contact to be a friend of the user if the user contact has stored the phone number in a device associated with the user contact; and
provision a friend request to the user contact if the user contact has not stored the phone number in the device.

19. The system of claim 13, wherein the networking application is configured to display on the user device interaction messages from at least one member from among the sub-network of members, and, wherein at least one interaction message from among the interaction messages relates to a request for availing a product or a service, an offer to sell an item or a service, a query for other members and an answer to a member query.

20. A computer program comprising program instructions which when executed by a user device, cause the user device to:
facilitate, upon user registration, a formation of a social network for a user of the user device, the social network comprising a plurality of members related to the user within a pre-defined degree of separation, each member from among the plurality of members associated with a credibility metric value;
receive user input indicative of user's interest to interact with other members on the social network, wherein a sub-network of members for the user to interact with is dynamically created based on the user input, the sub-network of members created by pruning one or more members from among the plurality of members associated with the social network at least based on the credibility metric value for the each member; and
display interaction messages from the sub-network of members.

21. The computer program of claim 20, wherein at least one interaction message from among the interaction messages relates to a request for availing a product or a service, an offer to sell an item or a service, a query for other members and an answer to a member query.

22. The computer program of claim 21, wherein the interaction messages are classified based on pre-defined categories, and, wherein the pre-defined categories comprise categories related to at least one of electronic devices and gadgets, automobiles, baby care, pet care, household help, food items, cooking recipes and travel.

23. The computer program of claim 22, wherein a display portion of a user interface (UI) corresponding to the displayed interaction messages is configured to expand and collapse based on a user selection of a category from among the pre-defined categories to enable the user to view related interaction messages on the same UI.

24. The computer program of claim 23, wherein a sideways scrolling display is facilitated for each interaction message from among the interaction messages to enable the user to view additional information related to the each interaction message on the same UI.
